(19) United States
(12) Patent Application Publication
(10) Pub. No.: US 2019/0113832 A1
(43) Pub. Date: Apr. 18, 2019

(54) OUTDOOR PROJECTOR DEVICE

(71) Applicant: PHILIPS LIGHTING HOLDING B.V., EINDHOVEN (NL)

(72) Inventors: Wei WANG, EINDHOVEN (NL); Caijie YAN, EINDHOVEN (NL); Bo PAN, EINDHOVEN (NL)

(21) Appl. No.: 16/088,562

(22) PCT Filed: Apr. 19, 2017
(86) PCT No.: PCT/EP2017/059269

§ 371 Date: Sep. 26, 2018

(30) Foreign Application Priority Data
Apr. 28, 2016 (CN) PCT/CN2016/080482
May 20, 2016 (EP) 16170509.0

(51) Int. Cl. G03B 23/10; G09F 13/04; G09F 19/18; F21S 10/00; F21S 9/04

(52) U.S. Cl. CPC G03B 23/105; G09F 13/04; F21W 2121/00; F21S 10/007; F21S 9/043; G09F 19/18

(57) ABSTRACT

The invention provides an outdoor projector device for generating a patterned light output, the patterning of the light being achieved at least partly by means of a rotatable beam patterning element being mechanically driven by means of a mechanically coupled wind turbine element.

### FIELD OF THE INVENTION

This invention relates to an outdoor projector device, in particular an outdoor projector device for generating a light pattern which may provide a decorative effect.

### BACKGROUND OF THE INVENTION

One particular type of urban lighting which is commonly used in public spaces is projection lighting, wherein a luminaire is used to project a pattern or image onto a target surface such as the façade of a building or an area on the ground. Such projections may be used to provide a decorative or aesthetic effect, or may be used to convey information, or advertising messages for instance.

Many known state of the art projector devices make use of a patterned mask or patterned translucent film or screen, onto which light is projected in order to create the patterned output or image. It is often desirable to create a patterned output in which the displayed pattern exhibits motion or variation. This can make the resultant display more interesting and engaging for an observer.

One well known means for achieving this is to provide a projector device in which the patterned mask or screen is controlled to rotate. However, for such devices, the rotation is typically generated by means of an electric motor, which provides a controlled and predicable rate of rotation. Variation in the rate is achievable, but only by means for instance of an additional controller which is configured to provide variation in accordance with a pre-determined scheme or pattern. The produced lighting effect can as a result remain repetitive and unexciting for an observer.

There is a need for a simple projector device for projecting a light pattern onto a target surface wherein the device is capable of generating a dynamic patterned output offering an improved degree of variability or unpredictability in generated rates of motion.

### SUMMARY OF THE INVENTION

The invention is defined by the claims.

According to an aspect of the invention, there is provided an outdoor projector having a central axis, the projector comprising:

one or more light sources arranged to produce a luminous output;

a rotatable beam patterning element on said central axis arranged to pattern said luminous output; and

a wind turbine element mechanically coupled with the beam patterning element to drive rotation of the of the beam patterning element.

A dynamic lighting pattern is thus provided by embodiments of the invention through use of a beam patterning element configured to rotate about a central axis, the rotation providing a smooth variation or motion of the pattern of the light being emitted from the device.

Moreover, the rotation is facilitated by a mechanically connected wind turbine element. The wind turbine element provides an additional level of dynamism to the output pattern, since not only does the pattern itself appear to shift and change, but the rate and frequency of this change is itself also variable due to the variability of wind strength. Moreover the variability of this rate is not pre-determined but is at least partly determined by current environmental factors, so that the pattern appears to change directly in response to the changing wind speed and/or direction (faster wind speed results in faster rotation, and hence more rapid pattern variation). This interaction with the environment hence not only provides a convenient and simple means of effecting the dynamic pattern variation, but also renders the generated display more interesting and exciting to an observer. Furthermore, utilisation of the wind may eliminate the need for any analogue or digital circuitry for controlling the rotation, rendering the device functionally simple and energy efficient.

The central axis may in examples coincide with an axis of (for example circular) symmetry of the projector and/or the rotatable beam patterning element. However, in other examples, it may refer simply to an axis extending through a central point of the projector, where said central point may correspond to an absolute centre of the projector and/or beam patterning element, or to a centre of gravity of the projector and/or beam patterning element, but may alternatively refer simply to a point located generally or substantially towards a central region of the projector and/or beam patterning element.

The beam patterning element is adapted to optically process or operate on the luminous output received from the one or more light sources in such a way as to transform it into a luminous output exhibiting a particular pattern and/or shape. This may in examples be achieved through absorption or reflection of one or more portions of the received luminous output and/or through diffraction or scattering of one or more portions or rays of the received luminous output.

It is emphasised that the wind turbine element does not refer to a unit adapted to generate any form of electrical energy. It refers to a purely mechanical unit or component adapted to transform or transfer kinetic energy held or expressed by moving air into rotational kinetic energy. In many cases, this may comprise a unit adapted to transfer or transform or redirect linear kinetic energy of moving air into rotational kinetic energy, typically rotational kinetic energy then embodied or expressed by a spinning spindle or axle of the turbine element. This rotational kinetic energy is mechanically transferred to the beam patterning element.

In examples, an electrical generator unit may further be provided in mechanical connection with the wind turbine element, for converting kinetic energy of the turbine element into electrical energy. However, this is a purely optional additional feature.

Further to the above, it has been recognised by the inventors of the presently claimed invention that state of the art projector devices typically produce light patterns which are undesirably small in cases where the projector is positioned relatively close to the target surface. This means that where it is desired to create a large, expansive light pattern across a target surface, this typically requires positioning the projector a large distance away from the target surface.

The inventors have recognised that this deficiency results from the fact that current state of the art projectors are configured to emit light patterns in such a way that they spread or diverge outwards from the device at a rate (with respect to distance from the device) which is undesirably slow. It would thus be desirable to provide a projector offering an improved rate of image divergence, such that large projections may be provided using devices positioned much closer to the target surface.

Accordingly, there is provided in accordance with one or more embodiments of the invention, a projector as described above, further comprising one or more optical elements arranged between the one or more light sources and said beam patterning element for collimating said luminous output, wherein each light source is arranged to direct its luminous output towards a respective one of said optical elements.

In particular, the one or more light sources and said one or more optical elements may form a light source arrangement configured to produce an annularly divergent luminous output directed onto said beam patterning element.

By annularly divergent is meant spreading or diverging outwards as though, or in fact, from a central originating point or central originating axis or contour. In particular, the annularly divergent luminous output may annularly diverge or spread outwards as though from one or more points along central axis of the projector. The annularly divergent luminous output may annularly diverge or spread outwards as though from an annular contour or line encircling the central axis. In one or both of these cases, annularly divergent may refer for example to substantially spherical-like divergence or expansion, as in the form of a spherical plane wave propagating outward from a central point or central line or contour. It may refer to radial divergence. The term annular need not refer to a circularly symmetric form, but may refer instead to any part or whole of a closed loop or ring for instance.

By directing an annularly divergent luminous output onto the beam patterning element, a luminous output is generated emanating from the beam patterning element, and hence the projector as a whole, which itself exhibits the same divergent character. By altering the configuration and/or arrangement of the optical elements, annular divergence of any desired rate or gradient may be achieved. In particular, a relatively rapid divergence may be established, whereby the luminous output expands to cover or encompass a large area in a relatively (in comparison with prior art devices) short time (or distance). This means that relatively large patterned lighting displays or effects (displays which cover or extend over a large area) may be generated by means of a projector device positioned at a relatively (in comparison with the prior art) close distance from a target surface.

The capacity to generate large-area patterns or images by means of a device positioned relative close the target area confers many advantages. In particular, installation of projectors may be simplified, since it is not necessary to identify and/or construct suitably remote points from the target area for installation of the device, and nor is it necessary to achieve or reach access to particularly high or elevated points or sites for installation of the projector, either of which may add time, cost and complexity to the process of installation of projectors. Similarly, maintenance of projectors is also simplified, since access is easier when projectors are not installed at very high or otherwise remote locations, where specialist skills and/or special permissions may be required to reach them or to gain access.

According to at least one set of examples, each of the one or more light sources may be mounted such that its optical axis is under a non-zero angle with the central axis. These non-zero angles may be collectively arranged so as to together provide or generate from the light sources an outwardly (radially from the central axis) propagating luminous distribution exhibiting an annular divergence.

In particular examples, the one or more light sources may form an annular array or arrangement of light sources, where this may consist of an arrangement wherein the locations of the light sources define the whole or a part of a closed loop or ring (i.e. an annulus). The optical axes of the light sources may be collectively arranged so as to intersect the beam patterning element across a set of points which together define or delineate an annular contour or figure.

The projector may in certain examples further comprise a carrier having a truncated conical section, wherein the one or more light sources are mounted on the sidewall of said truncated conical section. The truncated conical section may comprise a solid conical frustum for instance or may alternatively comprise a frame or mounting element consisting merely of the outer walls of a conical frustum.

Each optical element may be mounted such that its optical axis coincides with the optical axis of one of the one or more light sources. In this way, each optical element is mounted at a position directly facing or overlaying a respective one or more of the light sources, and configured to re-propagate or transmit received light along the same direction as received.

Alternatively, one or more of the optical elements may be mounted such that its optical axis is at a non-zero angle with the optical axis of one of the light sources, but nonetheless intersects a light emitting portion of said one or more of the light sources. In this case, the optical elements may be configured to change the direction of the received light, so that it is propagated along the direction of the non-coincident optical axis of the optical element.

Each optical element may be mounted in an annular support frame.

In accordance with at least one set of embodiments, each optical element may comprise a collimating lens, said collimating lens comprising:

a lens body, having
a light exit window comprising a domed central region surrounded by an annular portion that convexly extends from the perimeter to the domed central region, and
a total internal reflection sidewall extending from the light exit window; and

a central cavity for receiving a light source opposite the light exit window, the cavity comprising a cavity roof for guiding a first light portion emitted by the light source onto the domed central region and a cavity sidewall for guiding a second light portion emitted by the light source onto the total internal reflection sidewall,

wherein the total internal reflection sidewall is arranged to reflect the second light portion towards the annular section.

The thus provided collimating lens is particularly adapted to provide a collimated luminous output which has improved luminous uniformity across the exit window compared with similar collimating lenses known in the art. In particular, manufacturability requirements may often impose internal angular constraints (draft requirements) which lead to a non-negligible gap or space in the generated luminous output across the exit window. In examples of the present invention, this may result in the presence of a dark ring in the luminous output which is directed onto the beam patterning element.

In normal circumstances, this ring might naturally be expected to disappear as the luminous output propagates further through space, and the relative angles of the rays composing the luminous output intersect and cohere to form a uniform luminous distribution. However, due to the interruption of the beam patterning element in embodiments of the present invention, this self-correction is at least partially disrupted, meaning that the resultant luminous output emitted by from the projector may exhibit dark regions or lines.

Additionally, the patterning of the luminous output may be compromised, since certain portions of the beam patterning element may not receive illumination and hence the resultant patterned output may be imperfect or incomplete.

The collimating lens of the above described embodiment remedies these deficiencies through providing a cavity adapted to guide a portion of light emitted by a light source onto a total internal reflection (TIR) sidewall of the lens, wherein the TIR sidewall is angled, shaped or otherwise configured to direct part of this received light portion onto the annular portion of the exit window. This ensures that no dark spaces or rings are present across or around this annular portion, where they might otherwise standardly be expected to appear.

The annular portion of the light exit window extends convexly from the perimeter of the window to the domed central region. By ‘extends convexly’ is meant extends to define at least a portion of a convex surface. The annular portion may for example define a curved inclined surface extending from the perimeter and inclining to meet the central region.

According to examples, the each of the one or more light sources may be mounted such that its optical axis is under an angle of between 15° and 45° with the central axis. An angle of 22 degrees for instance has been found by the applicant to generate an output pattern on an incident surface having a diameter which is 1.3 times the distance between the projector and the surface.

In accordance with at least one set of embodiments, the beam patterning element may comprise an opaque body delimiting an annular pattern of light-transmissive areas. The beam patterning element comprises in this case a beam-patterning mask, adapted to shape the outgoing luminous distribution through absorbing selected portions of the luminous output received from the one or more light sources. Those portions of the received luminous output which fall incident on the light-transmissive areas are not absorbed and together define the generated output beam pattern emitted from the projector.

In examples, the light-transmissive areas may comprise light-transmissive window elements formed of a light-transmissive material. Alternatively, the light-transmissive areas may comprise openings or apertures in the opaque body.

The light transmissive areas may comprise window elements adapted to transmit only a portion of the spectral composition of the light emitted by the one or more light sources. This may have effect of tinting or colouring the patterned light output transmitted through the respective beam-pattern element.

The light transmissive areas may be translucent or transparent. The light transmissive areas may be comprised of two or more subsets of light transmissive areas, each subset having a different light transmissivity. Transmissivity may refer to the degree of absorption by the transmissive area of all spectral frequencies of light (i.e. the opacity of the area to white light), or may refer to the degree of absorption by the area of a particular set of spectral frequencies of light (i.e. its opacity or transmissivity to a particular colour or set of colours of light).

The opaque body may comprise a further truncated conical section including the annular pattern of light-transmissive areas. This truncated conical section may be a solid conical frustum or may for example consist of walls defining the outer surface of a conical frustum.

The shaped light-transmissive areas of the beam patterning element may comprise shaped apertures having a regular or freeform shape. The shaped apertures may for example define a regular geometric form or shape. Alternatively they may be shaped to define or to represent a particular image or object. They may be shaped to define letters, numerals or words. The apertures together may be shaped to define words intended to convey or to communicate information or a message.

In accordance with one or more embodiments, the beam patterning element may comprise a transmissive body comprising a random distribution of light scattering regions. In this case, the beam patterning element is adapted to shape the beam not substantially through absorption, but rather through deflection or scattering of the light, the scattered light forming a speckled or dappled light pattern which may provide an interesting or appealing aesthetic effect to an observer when projected onto a receiving target surface.

In one or more further examples, the beam patterning element may comprise one or more optical bodies adapted to refract and/or reflect at least a portion of the received light, this having the effect of shaping or patterning the light.

In accordance with at least one set of embodiments, the wind turbine element may be mechanically coupled to the beam patterning element via a configurable mechanical coupling element having a first configuration in which the wind turbine element is mechanically engaged with the beam patterning element and a second configuration in which wind the turbine element is mechanically disengaged from the beam patterning element. This enables the rotation of the beam patterning element, and hence the movement or transition of the patterned light output, to be controlled. The decoupling may be implemented by a manual mechanical control, or by a mechatronic means, such as an actuator or motor. In either case, the control may be manually regulated, by for example user input commands in the case of mechatronic control, or automatically regulated by a processor or computer.

In accordance with any of the described embodiments, the projector may further comprise one or more imaging lenses arranged to focus the patterned luminous output.

### BRIEF DESCRIPTION OF THE DRAWINGS

Examples of the invention will now be described in detail with reference to the accompanying drawings, in which:

FIG. 1 schematically depicts an exploded view of an example projector in accordance with an embodiment of the invention;

FIG. 2 schematically depicts a perspective view of an example projector;

FIG. 3 schematically depicts a side view of an example projector;

FIG. 4 schematically depicts a front view of an example projector;

FIG. 5 schematically depicts a rotatable mechanical coupling as comprised by one or more embodiments of the invention;

FIG. 6 schematically depicts part of an example optical arrangement embodied by an example projector;

FIG. 7 schematically depicts part of a second example optical arrangement embodied by an example projector;

FIG. 8 schematically illustrates part of a light path through an example projector;

FIG. 9 schematically depicts an example beam-patterning element;

FIG. 10 schematically depicts an example collimating lens as comprised by one or more embodiments of the invention; and

FIG. 11 illustrates the shape of an example collimating lens as comprised by one or more embodiments of the invention.

### DETAILED DESCRIPTION OF THE EMBODIMENTS

The invention provides a projector device for generating a patterned light output, the patterning of the light being achieved at least partly by means of a rotatable beam patterning element being mechanically driven by beans of a mechanically coupled wind turbine element.

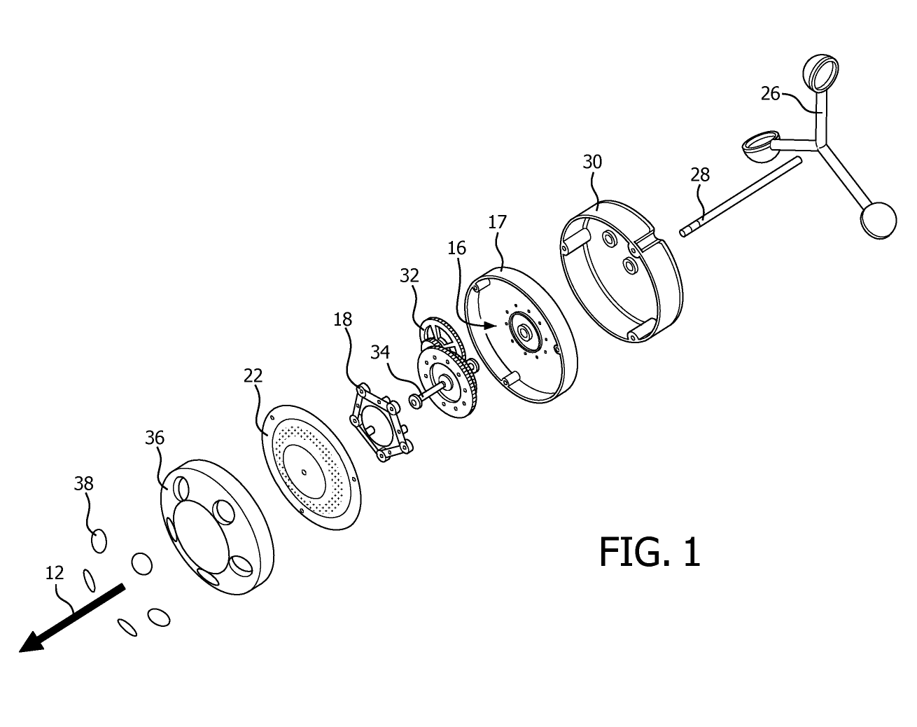

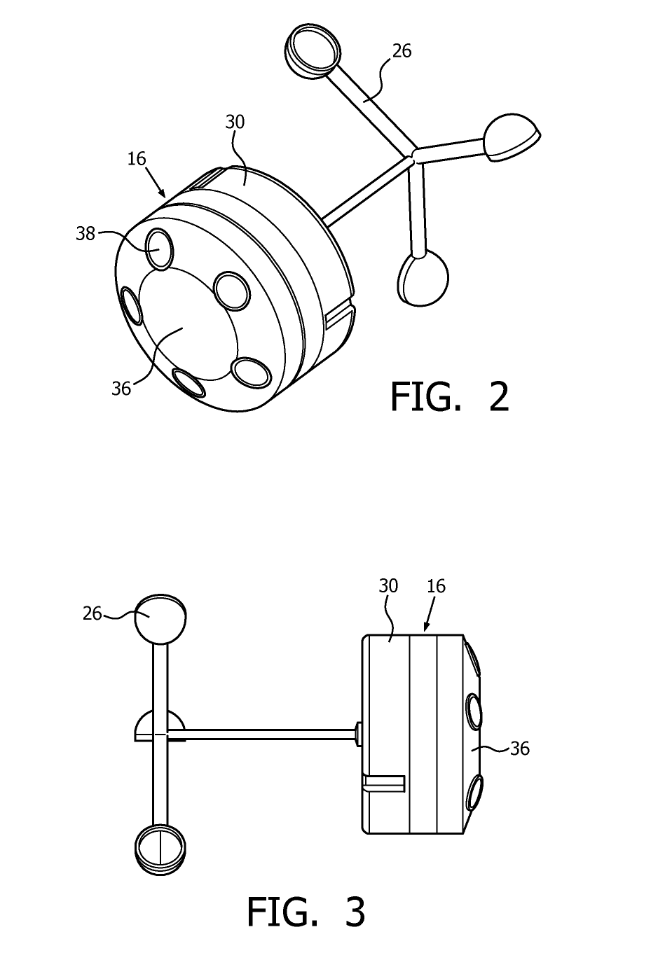

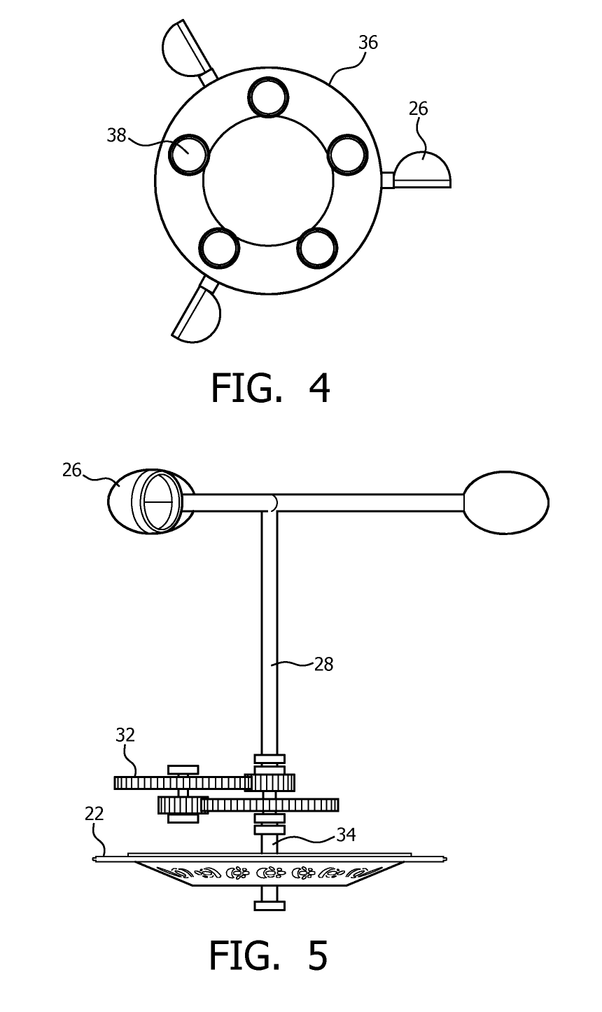

FIG. 1 schematically depicts an exploded view of an example projector device in accordance with one or more embodiments of the invention. FIGS. 2-4 schematically depict perspective, side and front views respectively of the same example projector in assembled form.

The projector is formed from a plurality of parts which are assembled together in a layer-like structure along a central axle 28, the central axle defining a central axis (and corresponding axial direction) 12 running through the projector.

Nested within a rear portion 30 of a housing structure of the projector is a carrier element 17, to which are mounted a plurality of LED light sources 16. The LED light sources are configured to direct a luminous output onto an annular array of optical elements 18, arranged axially adjacent to the carrier element 17 and LED light sources 16. The optical elements are adapted and arranged to direct the received luminous output onto a surface of an axially adjacent beam-patterning element 22, which is configured to pattern the light and to direct this patterned luminous output in the direction of a front portion 36 of the projector housing. The front portion 36 of the housing may embody or delimit an annular array of substantially circular apertures, arranged to receive or house a corresponding array of imaging lenses 38 for focussing or directing the patterning light output to generate and project a final luminous output from the projector

The mechanical configuration of the projector may be seen in the exploded view of FIG. 1 and is further shown in isolation in FIG. 5. The central axle 28 is mechanically coupled at a first end to a wind turbine element 26 such that rotation of the wind turbine element induces corresponding rotation of the central axle. The central axle extends through the projector housing and carrier element 17 and makes mechanical connection at a second end with a rotatable mechanical coupling element 32. The rotatable mechanical coupling may comprise for instance a cam wheel arrangement, or similar, for transferring or transmitting rotational motion.

The rotatable mechanical coupling element 32 is further mechanically coupled via a secondary axle 34 with the beam-patterning element 22, such that rotation of said secondary axle 34 induces corresponding rotation of the beam-patterning element 22. The rotatable mechanical coupling 32 is configured to provide transmission of the rotational motion of the central axle 28 to the secondary axle 34. Thus, rotation of the wind turbine element 26 is configured, via the mechanical coupling 32, to drive a corresponding rotation of the beam patterning element.

As the beam-patterning element rotates, the patterning of the patterned light output varies and shifts accordingly. Hence, rotation of the wind turbine element is configured to drive a corresponding variation in the pattern of the final light output emitted from the projector.

In some examples, the secondary axle 34 may additionally be mechanically coupled with the array of light sources 16, such that rotation of the wind turbine element 26 drives simultaneous and parallel rotation of both the light sources and the beam patterning element.

According to one or more examples, the rotatable mechanical coupling 32 may be configurable to switch between a first configuration in which the wind turbine element 26 is mechanically engaged with the beam patterning element, and a second configuration in which the beam patterning element is mechanically disengaged from the beam patterning element. The mechanical coupling thus provides according to these examples a means for selectively engaging and disengaging the beam-patterning element from the wind turbine element 26, and thus selectively activating or deactivating the rotational variation of the beam patterning.

This may be achieved in examples by means of a mechanical disengagement mechanism which is manually controllable by a user or operator (for instance by a physical lever) to mechanically disengage the central axle 28 from the secondary axle 34. Additionally or alternatively, it may be achieved by means of a mechatronic or other electronically controllable mechanism for disengaging the central axle from the secondary axle. In examples this may comprise one or more actuators for providing mechatronic engagement and disengagement. A mechatronic means may be configured to be controllable by a processor wherein the processor may be programmable to effect disengagement and/or engagement automatically and/or the processor may be configured to be responsive to user input commands to effect disengagement and/or engagement.

Furthermore, in accordance with specific examples, the rotatable mechanical coupling may provide a variable transmission functionality, wherein the application of power provided by the wind turbine element to the secondary axle 34 may be variably controlled. This may be achieved for example by means of a gearing or other such transmission mechanism. Thus, according to these examples, the mechanical coupling is configurable to apply for instance only a portion of the power generated by the rotating wind turbine element 26 to the secondary axle 34 and hence to the beam-patterning element 22. This enables the wind to provide the substantial driving force for rotating the beam patterning element 22, while maintaining for a user or operator of the device a degree of control over at least a maximal speed of rotation of this element.

In accordance with one or more examples, the carrier element 17 may comprise one or more printed circuit boards (PCBs) to which the plurality of LED light sources are mounted. The element may comprise one or more carrier surfaces, oriented directly facing the array of optical elements 18, these one or more carrier surfaces comprising one or more mounted PCBs to which are coupled the LED light sources.

According to examples, each of the plurality of LED light sources 16 may comprises a single LED or may comprise a plurality of LEDs. The plurality of LED light sources 16 may be configured to be individually addressable, or may on the contrary be addressable only as a group. Individual addressability may facilitate greater flexibility in the lighting displays which may be generated by the projector, including for instance selective illumination of only certain portions of a beam-patterning element 22. Furthermore, the plurality of LED light sources may, individually or collectively, be configured to have adjustable light output intensity. There may be provided one or more drivers or controllers for facilitating one or more of these functions.

In addition, LEDs may be provided which are adapted to emit light of different colours. The plurality of LEDs may comprise two or more subsets of LEDs, each subset configured to emit light of a different colour. Each colour subset may be individually addressable. Each colour subset may have individually adjustable light output intensity. One or more of the subsets or one or more of the plurality of light sources may be configured or may be operable to emit light of more than one colour, either simultaneously or at different times.

Although in the example of FIGS. 1-4, the projector comprises LED light sources, in alternative examples, different light sources may be utilised, for example a different type of solid-state light source may be used, such as OLEDs, or alternatively one or more filament or fluorescent light sources may be used. LEDs confer the advantages, inter alia, of high energy efficiency, long life-time and low heat generation.

The wind turbine element may comprise or consist of any form of energy capture or conversion unit which is adapted to convert or transfer kinetic energy of moving air into rotational kinetic energy of central axle 28. In particular, the wind turbine element of the example of FIGS. 1-4 is adapted to convert substantially linear kinetic energy of moving air into rotational kinetic energy of the central axle 28.

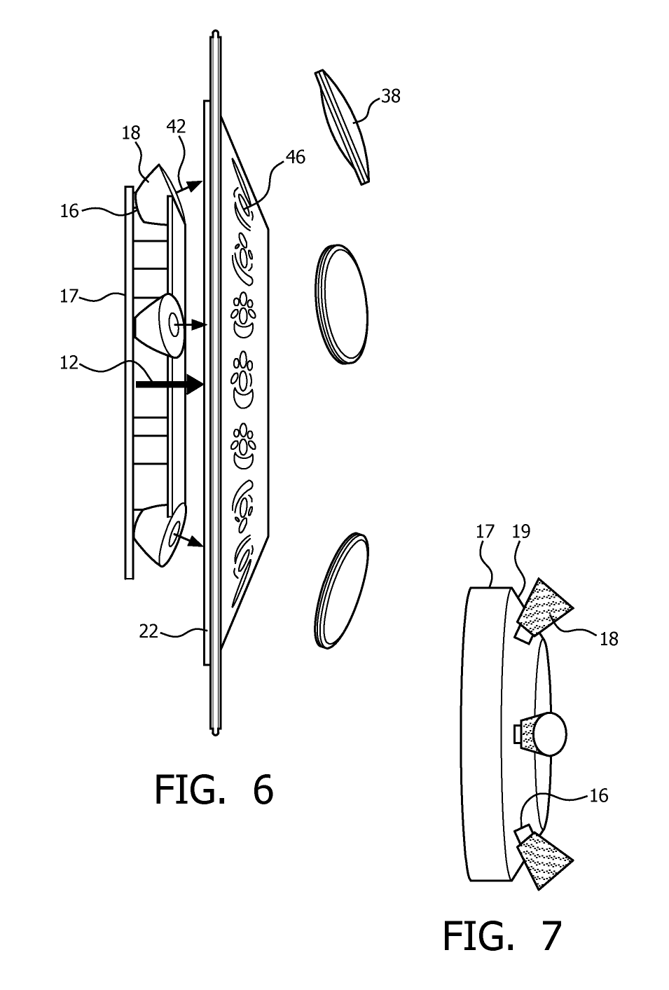

FIG. 6 schematically depicts the optical arrangement of an example projector in accordance with at least one embodiment of the invention. The depicted arrangement comprises a plurality of LED light sources 16 mounted to a carrier plate 17, and wherein an annular array of optical elements 18 (only three of which are visible from the side-view shown) is arranged directly overlaying the light sources, one optical element being arranged directly overlaying and optically engaged with each of the plurality of light sources.

The optical elements 18 of the annular array are each oriented having a respective optical axis 42 arranged at a non-zero angle with respect to the central axis 12 of projector. More particularly, optical axes of the array of optical elements are configured to collectively define an annularly divergent optical output; wherein light emitted from the array forms a luminous output which spreads outwards in directions tangential to the central axis 12. In particular, where the central axis 12 defines an axial direction, the optical axis 42 of each optical element is oriented in a direction having components in a radial direction.

In accordance with one or more examples, each optical element may be directly mechanically coupled to a lower light input area of a respective optical element. Alternatively, in other examples the plurality of light sources may be mounted on the carrier and at some axial displacement from the optical elements, but arranged at angles such that their respective optical axes coincide with the optical axes of the optical elements.

In particular examples for instance, the carrier may comprise a truncated conical portion, and wherein the plurality of light sources are mounted at points around an outer (inclined) surface of this truncated conical portion. An example of such an arrangement is schematically depicted in FIG. 7, which shows a carrier plate 17 having truncated conical lip 19 having an outer surface to which are mounted an annular arrangement of light sources 16. Arranged atop the light sources is a corresponding annular arrangement of optical elements 18. As shown, the gradient of the outer surface of the conical portion is such as to dispose the light sources in optical alignment with the respective optical axes of the optical elements.

The effect of the optical arrangement in any of the above example cases is to direct a radially or annularly spreading or divergent luminous distribution onto the beam-patterning element 22. The beam shaping element in the example of FIG. 6 comprises a beam-patterning mask formed of an opaque plate delimiting an annular arrangement of shaped light-transmissive areas 46. The light transmissive areas thus pattern the light in accordance with the shapes defined by these areas.

Light passing through the light transmissive areas of the beam-patterning mask 22 continues to propagate along the radially or annularly divergent path into which it was directed by the array of optical elements. The patterned luminous output produced by the beam-patterning element thus continues to radially or annularly spread outwards from the central axis 12 as it passes from the beam patterning element and toward the array of imaging lenses 38. The imaging lenses are mounted or supported by the front housing portion 36 in an annular arrangement in which the optical axis of each lens is oriented in a direction having radial components. The lenses are thus arranged and oriented to receive the annularly divergent patterned luminous output, and to focus or direct this light outwards from the projector along a similarly divergent path (or set of paths).

Since the patterned light output generated by the beam-patterning mask 22 annularly or radially diverges, the annular arrangement of imaging lenses 38 may be arranged about an annulus having a greater radius than the corresponding annulus of the annular arrangement of light transmissive areas 46.

It is to be noted that although the in the example optical arrangement of FIG. 6, the optical elements 18 define an annular array of optical elements, in other examples, different arrangements or patterns of elements may alternatively be used. The optical elements may comprise a different shape or configuration of regular array or irregular pattern or distribution. The optical elements may be arranged in a semi-random distribution. The pattern or arrangement of the plurality of light sources 16 may similarly vary in alternative embodiments.

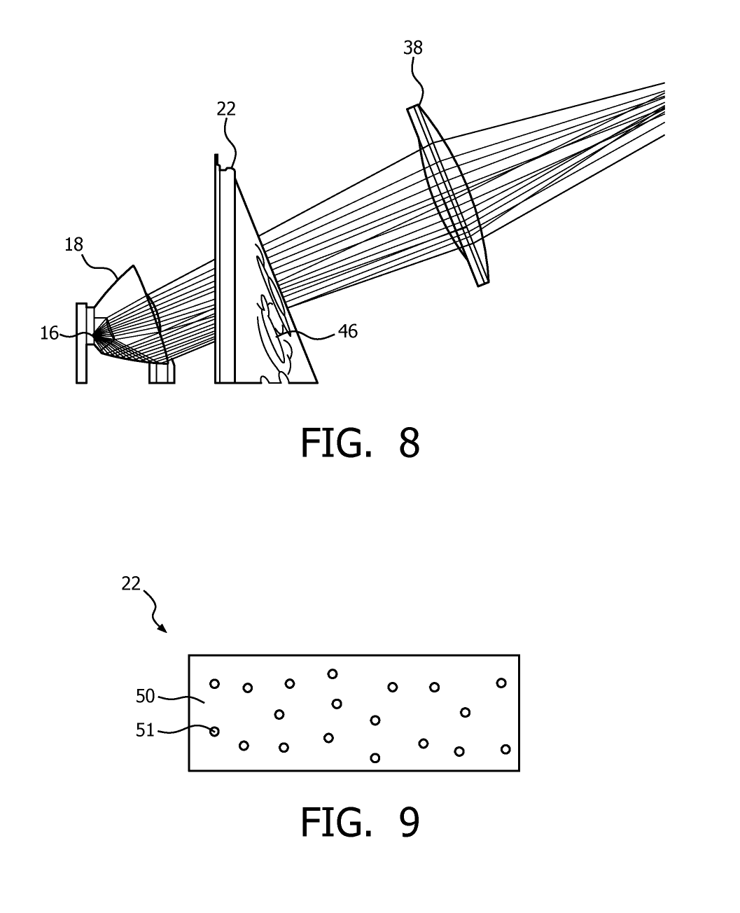

The path of the luminous output emitted from a single example optical element is shown more clearly in FIG. 8. The example optical element 18 directs light generated by example LED light source 16 along a path radially tangential to the central axis 12, and toward a respective one of the light transmissive areas 46 of the beam patterning element 22. As shown, the light transmitted through the light-transmissive area 46 continuous along the radially tangential path toward a respective one of the array of imaging lenses 38, which is adapted to focus or converge the incoming light to generate a corresponding focussed output beam from the projector.

In examples, the beam shaping element may comprise an opaque plate or disk element delimiting an annular array of light-transmissive areas.

According to further examples, the beam-patterning element may comprise a substantially light-transmissive body comprising a plurality of light-scattering regions. An example portion of such a beam-patterning element is schematically depicted in FIG. 9. The element 22 comprises a transparent or translucent body 50 within which are disposed a random distribution of scattering elements 51, having the effect of scattering incident light in one or more directions. The beam patterning element 22 may comprise for instance a crystalline structure having natural beam-scattering features or particles formed within the body of the structure.

The optical effect of such an example beam patterning element is to generate a semi-random luminous pattern, consisting of a generally diffuse luminous distribution interspersed with a random distribution of bright, high intensity spots. This may create for instance an dappled light effect.

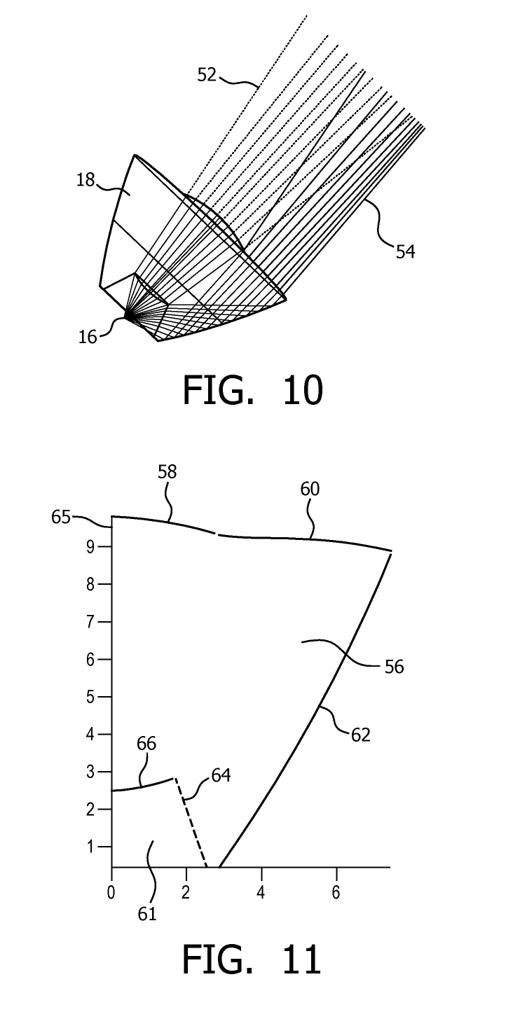

In accordance with at least one set of embodiments, the optical elements 18 may each consist of a collimating lens, adapted to generate a substantially uniform collimated beam. An example of such a collimating lens is schematically illustrated in FIG. 10. FIG. 11 depicts the internal shape or profile of the lens.

The collimating lens 18 comprises a lens body 56 having a light exit window comprising a domed central region 58 surrounded by an outer annular portion 60 which extends convexly from the perimeter of the lens body 56 to the domed central region 58. The lens body 56 further comprises a total internal reflection (TIR) sidewall 62 extending from the outer annular portion 60 of the light exit window to the base of the lens body. At the base of the lens is a central cavity 61 delimited by the lens body 56. Although the diagram of FIG. 11 depicts only one half of the lens, it is to be understood that the depicted shape and profile is symmetrically replicated on the alternate side (including an equivalent TIR sidewall).

In order to conform with manufacturability requirements in the case that the collimating lenses 18 are formed through a casting process, the draft angle both of cavity sidewall 64 and TIR sidewall 62 must be at least non-zero (with respect to a central vertical axis 65). One consequence of this is that there necessarily results a non-negligible ‘horizontal’ separation between the end of the cavity roof 66 and the beginning of the lens body sidewall 62.

In state of the art collimating lenses, this separation typically leads to the production of a corresponding dark ring within the generated collimated beam at the point of the light exit window 58, 60. As the beam propagates from the lens, the rays composing it tend after some determinable distance to converge, such that the dark ring is eliminated. However, since in examples of the present invention, the beam-patterning element may be placed very close to the light exit window 58, 60 of the lens body, the generated collimated beam may typically fall incident on the beam-patterning element before the ring has had time to eliminate itself through natural convergence.

In order to avoid the presence of dark rings within the luminous distribution directed onto the beam-patterning element, the collimating lenses 18 as comprised by one or more embodiments of the present invention are configured to correct for the non-negligible separation between the cavity roof 66 and the TIR sidewall 62 within the body 56 of the lens itself.

As shown in FIG. 10 and FIG. 11, the cavity roof 66 is adapted to refract a first light portion (rays 52) as they pass into the lens body 56 such that they fan or spread outwards, wherein this spreading is such as to direct light so as to completely cover the central domed region 58 of the light exit window. Furthermore, the cavity sidewall 64 is adapted to guide a second light portion (rays 54) from the light source to fall across the entirety of TIR sidewall 62 at such an angle that upon reflection from the TIR sidewall they are directed to cover the entirety of the outer annular portion 60 of the light exit window.

Hence, the cavity and lens body are adapted to provide a substantially even distribution of light across the entirety of the light exit window 58, 60. Furthermore, according to at least one set of examples, the central domed region 58 of the light exit window is optically adapted to refract outgoing rays 52 upon passing out of the lens body such that they fan or spread outwards, as shown in FIG. 10. Additionally, the outer annular portion 60 of the light exit window may be optically adapted to guide outgoing rays 54, for example by refraction, to deflect or spread in a radially (or annularly) inward direction, such that the rays spread onto or overlap with the outgoing rays 52 exiting through the central domed region 58 of the light exit window. As a result, the outgoing light portions 52, 54 of the luminous distribution exiting through the central domed region 58 and outer annular region 60 respectively of the light exit window rapidly mix or combine as they propagate from the collimating lens 18, such that a single uniform outgoing beam is provided exhibiting no dark regions or patches, and in particular no dark ring(s).

It is noted that although in the example illustrated in FIGS. 10 and 11, the cavity roof 66 is slightly concave, according to alternative examples the roof surface may be a different shape, with a profile following a different (i.e. non-concave) form or shape. A concave roof confers the advantage that the collimating lens 18 may be provided having smaller outer dimensions, since the required optical effects may be generated by a cavity having a roof of radially narrower dimensions. By providing a cavity roof 66 which is concave, a desired roof surface area may be provided with a surface of smaller (compared with a flat surface) radial extension.

By way of one illustrative example only, the central cavity 61 may have an maximum internal extension of between 4.2 and 4.6 mm, and the cavity roof 66 may exhibit a slope angle of between 22 and 26 degrees, for example 22 degrees. It is emphasised however, that embodiments of the invention are not limited to these dimensions, and other dimensions may equivalently be used in other examples.

Projector devices in accordance with embodiments of the invention may be advantageously applied in particular to the generation of lighting patterns for display in public urban spaces such as squares, shopping centres or shopping streets. The projectors may be used to project lighting displays intended to provide a decorative effect. Additionally or alternatively, they may be used to project light displays intended to convey information such as directions or advertising messages.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An outdoor projector having a central axis, the projector comprising:
one or more light sources arranged to produce a luminous output;
a rotatable beam patterning elements on said central axis arranged to pattern said luminous output; and
a wind turbine element mechanically coupled with the beam patterning element to drive rotation of the beam patterning element.

2. A projector as claimed in claim 1, further comprising one or more optical elements arranged between the one or more light sources and said beam patterning element for collimating said luminous output, wherein each light source is arranged to direct its luminous output towards a respective one of said optical elements.

3. A projector as claimed in claim 2, wherein said one or more light sources and said one or more optical elements form a light source arrangement configured to produce an annularly divergent luminous output directed onto said beam patterning element.

4. A projector as claimed in claim 3, wherein each of the one or more light sources is mounted such that its optical axis is under a non-zero angle with the central axis.

5. A projector as claimed in claim 4, further comprising a carrier having a truncated conical section, wherein the one or more light sources are mounted on the sidewall of said truncated conical section.

6. The projector as claimed in claim 4, wherein each optical elements is mounted such that its optical axis coincides with the optical axis of one of the one or more light sources.

7. The projector as claimed in claim 6, wherein each optical elements is mounted in an annular support frame.

8. A projector as claimed in claim 2, wherein each optical element comprises a collimating lens, said collimating lens comprising:
a lens body, having
a light exit window comprising a domed central region surrounded by an annular portion that convexly extends from the perimeter to the domed central region, and
a total internal reflection sidewall extending from the light exit window; and
a central cavity for receiving a light source opposite the light exit window, the cavity comprising a cavity roof for guiding a first light portion emitted by the light source onto the domed central region and a cavity sidewall for guiding a second light portion emitted by the light source onto the total internal reflection sidewall,
wherein the total internal reflection sidewall is arranged to reflect the second light portion towards the annular section.

9. A projector as claimed in claim 4, wherein the non-zero angle is between 15° and 45°.

10. A projector as claimed in claim 1, wherein the beam patterning element comprises an opaque body delimiting an annular pattern of light-transmissive areas.

11. A projector as claimed in claim 10, wherein the opaque body comprises a further truncated conical section including the annular pattern of light-transmissive areas.

12. A projector as claimed in claim 10, wherein said light-transmissive areas comprise shaped apertures having a regular or freeform shape.

13. A projector as claimed in claim 1, wherein the beam patterning element comprises a transmissive body comprising a random distribution of light scattering regions.

14. A projector as claimed in claim 1, wherein the wind turbine element is mechanically coupled to the beam patterning element via a configurable mechanical coupling element having a first configuration in which the wind turbine elements is mechanically engaged with the beam patterning element and a second configuration in which wind the turbine element is mechanically disengaged from the beam patterning element.

15. A projector as claimed in claim 1, further comprising one or more imaging lenses arranged to focus the patterned luminous output.
